(19) United States
(12) Patent Application Publication
(10) Pub. No.: US 2007/0059226 A1
(43) Pub. Date: Mar. 15, 2007

(54) Control system for a boiler

(76) Inventors: John Fogarty, Kent (GB); Barbara Lefebvre, Smyrna, GA (US)

Correspondence Address: EPSTEIN & GERKEN, 1901 RESEARCH BOULEVARD, SUITE 340, ROCKVILLE, MD, 20850, US

(21) Appl. No.: 11/225,863

(22) Filed: Sep. 13, 2005

(51) Int. Cl. B01D 53/56

(52) U.S. Cl. 423/235; 422/110; 422/168

(57) ABSTRACT

A closed loop control apparatus for reducing nitrous oxide levels in combustion products created by a combustion process comprising: a reagent injection system; a controller for controlling an amount of reagent to be injected by the reagent injection system; and a first downstream measuring device adapted to provide a first output signal corresponding to a first measured parameter of the combustion products created by the combustion process, wherein the controller is adapted to control the amount of reagent to be injected in response to the value of the first output signal.

The present invention relates to control apparatus and methods for controlling the reduction of nitrous oxide (NOx) within a combustion process.

A number of NOx reduction technologies currently exist. These include Selective Catalytic Reduction (SCR), Selective Non-Catalytic Reduction (SNCR), Autocatalytic Process (for example, the NOxStar™ process of Mitsui Babcock and the process disclosed in U.S. Pat. No. 5,985,222, No. 6,066,303 and No. 6,348,178 to Sudduth et al), Rich Reagent Injection and reburn. All these technologies involve the use of an ammonia based reagent injection system to reduce the NOx levels in the flue gas. These systems limit the amount of ammonia injected into the system to avoid excessive unreacted ammonia, which is known as ammonia slip.

High ammonia slip has many disadvantages which include: damage or blockage caused to the down stream equipment, such as the formation of ammonium salts on the air pre-heater and other downstream surfaces; the fly ash becomes unusable for other purposes, or there is an ammonia odour from the fly ash; ammonium chloride smoke from the stack; and the emission of gaseous ammonia.

NOx reduction plants are typically operated well within operating limits in order to avoid ammonia slip. Therefore, improved control of ammonia slip could significantly reduce operating costs by allowing operation closer to the operating limits.

Furthermore, it is known that the level of ammonia slip that is needed to be maintained to avoid process problems varies depending on the process and conditions used. While sulphur content of the fuel plays a major role in determining the level of ammonia slip that is associated with an onset of problems, the boiler design, fly ash characteristics, and condition of the boiler are other important factors. Also, when the catalyst is new, it can achieve greater reductions of NOx while maintaining within required ammonia slip levels. However, the catalyst can lose its activity as a result of the deposition of impurities from the fuel onto the catalyst surface.

It is known to use an open loop control of the reagent injection to achieve the control of the degree of ammonia slip. Typically, ammonia slip values are determined at the commissioning stage or when carrying out regular manual checks during operation.

Ammonia monitoring is the only single indicator that can provide a direct measure of whether the NOx reduction system is being operated under, at, or beyond its limitations and by how much. Until recently, ammonia monitoring technology has been limited largely to natural gas fired applications or other clean gas applications. Such applications typically used monitoring techniques such as UV photometry, ion mobility spectroscopy or differential NOx analysis following conversion of ammonia to NOx. However, these monitoring techniques are generally unsuitable for the conditions that exist in coal plants such as high dust, high temperature, high NOx and/or high sulphur dioxide levels.

The on line measurement of ammonia slip has improved in recent years. In particular, new laser technologies, such as Tunable Diode Laser spectroscopy, make it possible to measure continuously the ammonia slip levels during the combustion process.

According to a first aspect of the present invention, there is provided a closed loop control apparatus for the reduction of nitrous oxide levels in the combustion products created by a combustion process comprising:

a reagent injection system;

a controller for controlling an amount of reagent to be injected by the reagent injection system; and

a first downstream measuring device adapted to provide a first output signal corresponding to a first measured parameter of the combustion products created by the combustion process,

wherein the controller is adapted to control the amount of reagent to be injected in response to the value of the first output signal.

Preferably the reagent to be injected comprises ammonia. Alternatively the reagent to be injected may comprise urea. Preferably the first measured parameter comprises the amount of unreacted ammonia. The amount may be measured as an absolute amount or as a concentration.

Preferably the controller comprises a Programmable Logic Controller.

Preferably the first downstream measuring device comprises a laser device.

Preferably the apparatus includes a second downstream measuring device adapted to provide a second output signal corresponding to a second measured parameter. Preferably the second downstream measuring device is a nitrous oxide measuring device and the second measured parameter is the amount of nitrous oxide. The amount may be measured as an absolute amount or as a concentration.

Preferably the nitrous oxide measuring device is an infrared device.

Preferably the controller is further adapted to control the amount of reagent to be injected in response to the value of the second output signal.

According to a second aspect of the present invention, there is provided a method of reducing nitrous oxide levels in the combustion products created by a combustion process comprising:

injecting a reagent into the combustion process;

controlling the amount of reagent injected; and

measuring a first measured parameter of the combustion products created by the combustion process,

wherein the step of controlling the amount of reagent injected corresponds to the value of the first measured parameter.

Preferably the reagent injected comprises ammonia. Preferably the first measured parameter comprises the amount of unreacted ammonia.

Preferably the method includes measuring a second measured parameter of the combustion products created by the combustion process. Preferably the second measured parameter is nitrous oxide.

Preferably the method includes controlling the amount of reagent injected in response to the value of the second measured parameter.

An embodiment of the present invention will now be described, by way of example only, with reference to the accompanying drawing, in which:

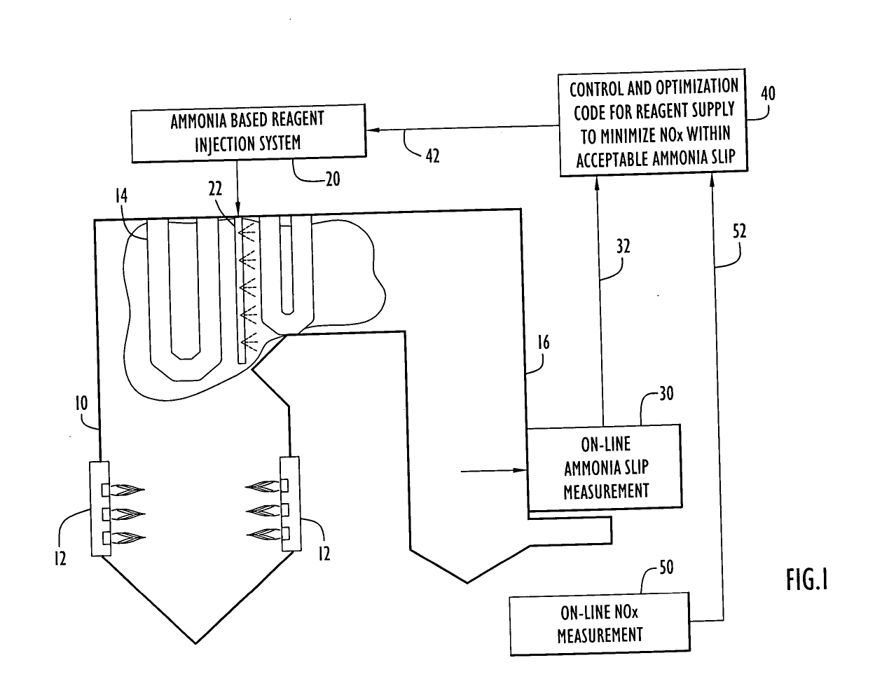

FIG. 1 is a diagrammatic view of the control apparatus used with a boiler.

FIG. 1 shows a boiler 10 having a number of wall mounted burners 12. The combustion products will include unwanted products such as nitrous oxide (NOx).

To reduce the amount of NOx downstream, an ammonia based reagent injection system 20 is provided. This is in the form of NOxStar™ ammonia and hydrocarbon injection based NOx reduction technology. The reagent is introduced after the first bank of the secondary superheater 14 using an injection manifold 22.

A first downstream measuring device 30 is provided for measuring a first parameter. The device is a laser device and the first parameter measured is ammonia slip. One example of such a device is Siemens Model LDS3000. These measurements are taken in the exhaust ductwork 16.

The laser device generates a first output signal 32 corresponding to the measured amount of ammonia slip. This signal 32 is transmitted to a controller 40, which is a Programmable Logic Controller (PLC). The PLC 40 utilises optimisation and control logic to feed back a control signal 42 to the reagent injection system 20. Thus, the controller is adapted to control the amount of reagent to be injected in response to the value of the first output signal 32.

The control apparatus also includes a second downstream measuring device 50, which is an infrared nitrous oxide measuring device. This is adapted to provide a second output signal 52 corresponding to a second measured parameter, which is the amount of nitrous oxide detected. One example of such a measuring device is Sick Maihik Model GM31.

The controller 40 is further adapted to control the amount of reagent to be injected in response to the value of the second output signal 52.

This invention utilises currently available NOx reduction technologies, either on their own or in various combinations, and combines them with on line ammonia slip and NOx measurements. These measurements are used within a control feedback loop to actively monitor and adjust the reagent injection to maximise the NOx reduction for the lowest ammonia slip level, and to improve the NOx reduction performance over a wider load range.

This feedback control is applicable to the performance improvement of all known ammonia based injection technologies for NOx reduction.

Various modifications and improvements can be made without departing from the scope of the present invention.

What is claimed is:

1. A closed loop control apparatus for reducing nitrous oxide levels in combustion products created by a combustion process comprising:
a reagent injection system;
a controller for controlling an amount of reagent to be injected by the reagent injection system; and
a first downstream measuring device adapted to provide a first output signal corresponding to a first measured parameter of the combustion products created by the combustion process,
wherein the controller is adapted to control the amount of reagent to be injected in response to the value of the first output signal.

2. An apparatus as claimed in claim 1, wherein the reagent to be injected comprises ammonia.

3. An apparatus as claimed in claim 1, wherein the reagent to be injected comprises urea.

4. An apparatus as claimed in claim 1, wherein the first measured parameter comprises an amount of unreacted ammonia.

5. An apparatus as claimed in claim 1, wherein the controller comprises a Programmable Logic Controller.

6. An apparatus as claimed in claim 1, wherein the first downstream measuring device comprises a laser device.

7. An apparatus as claimed in claim 1, including a second downstream measuring device adapted to provide a second output signal corresponding to a second measured parameter.

8. An apparatus as claimed in claim 7, wherein the second downstream measuring device is a nitrous oxide measuring device and the second measured parameter is the amount of nitrous oxide.

9. An apparatus as claimed in claim 8, wherein the nitrous oxide measuring device is an infrared device.

10. An apparatus as claimed in claim 7, wherein the controller is further adapted to control the amount of reagent to be injected in response to the value of the second output signal.

11. A method of reducing nitrous oxide levels in combustion products created by a combustion process comprising:
injecting a reagent into the combustion process;
controlling an amount of reagent injected; and
measuring a first measured parameter of the combustion products created by the combustion process,
wherein the step of controlling the amount of reagent injected corresponds to the value of the first measured parameter.

12. A method as claimed in claim 11, wherein the reagent injected comprises ammonia.

13. A method as claimed in claim 11, wherein the first measured parameter comprises an amount of unreacted ammonia.

14. A method as claimed in claim 11, including measuring a second measured parameter of the combustion products created by the combustion process.

15. A method as claimed in claim 14, wherein the second measured parameter is nitrous oxide.

16. A method as claimed in claim 14, including controlling the amount of reagent injected in response to the value of the second measured parameter.
